(19) United States
(12) Patent Application Publication
(10) Pub. No.: US 2010/0135030 A1
(43) Pub. Date: Jun. 3, 2010

(54) CEILING RECESSED-TYPE LAMP UNIT

(75) Inventor: Miyoji Ishibashi, Fukuoka (JP)

Correspondence Address: Fleit Gibbons Gutman Bongini & Bianco PL, 21355 EAST DIXIE HIGHWAY, SUITE 115, MIAMI, FL, 33180, US

(73) Assignee: TESCO. ECO LIGHTING CO., LTD., Fukuoka (JP)

(21) Appl. No.: 12/594,844

(22) PCT Filed: Dec. 13, 2007
(86) PCT No.: PCT/JP2007/074039

§ 371 Date: Jan. 22, 2010

(30) Foreign Application Priority Data
Apr. 6, 2007 (JP) 2007-100118
Nov. 5, 2007 (JP) 2007-287540

(51) Int. Cl. F21V 15/00

(52) U.S. Cl. 362/365

(57) ABSTRACT

Disclosed is a ceiling recessed-type lamp unit, which is capable of facilitating recessedly mounting a unit body to a ceiling, in a reliable manner regardless of a lamp unit's size. The lamp unit comprises a support member 3, and an engagement member 4. The support member 3 is formed with a latch portion adapted to engage the engagement member 4, and a guide groove successively extending from the latch portion downwardly. The engagement member 4 is formed with a first engagement portion 4a engageable with the latch portion, and a second engagement portion 4b engageable with a back surface of a ceiling T. The engagement member 4 is adapted to be rotated in a first direction about a vertical axis thereof, so that the first engagement portion 4a is latchedly engaged with the latch portion to allow the engagement member 4 to be set in a non-engagement position where the second engagement portion 4b avoids engagement with the back surface of the ceiling T. The engagement member is adapted, when it is in the non-engagement position, to be rotated in a second direction opposite to the first direction to release the engagement between the first engagement portion 4a and the latch portion, so that the engagement member 4 is moved downwardly along the guide slot by a biasing force of an elastic member, and set in an engagement position where the second engagement portion 4b is engaged with the back surface of the ceiling T.

### TECHNICAL FIELD

The present invention relates to a ceiling recessed-type lamp unit, such as a downlight fixture, which is designed to be recessedly mounted in an opening formed in a ceiling.

### BACKGROUND ART

A ceiling recessed-type lamp unit, such as a downlight fixture, is designed to be inserted from an opening formed in a ceiling from below the ceiling, and recessedly mounted to the ceiling (i.e., mounted to the ceiling in a recessed manner or in a substantially flush-mounted manner). Heretofore, there have been proposed various mounting structures for the recessed mounting.

A typical one of the mounting structures is a type based on a leaf spring. For example, the following patent Publication 1 discloses a mounting structure comprising a generally V-shaped leaf spring which has an anchor arm fixed to a lateral surface of a unit body of a ceiling recessed-type lamp unit, and a free arm extending obliquely upwardly from a lower end of the anchor arm, wherein the unit body is adapted to be forcibly inserted into an opening of a ceiling while bending the free arm of the leaf spring toward the unit body, and engagingly fixed to the ceiling by elastic restoring force of the leaf spring.

The leaf spring-based mounting structure has a problem that, if the elastic restoring force of the leaf spring deteriorates due to fatigue of the leaf spring or the like, the lamp unit is likely to wobble, or droop or fall down from the ceiling, only by a slight external force applied thereto. Although the mounting structure disclosed in the patent Publication 1 is designed to adjustably change a fixing position of the leaf spring so as to allow the elastic restoring force to be adequately set depending on mounting environments, it is unable to radically solve the above problem, as long as it is the leaf spring-based mounting structure. Moreover, in the leaf spring-based mounting structure, during an operation of demounting the unit body from the ceiling, the ceiling is likely to be damaged, because the unit body has to be forcibly pulled out of the ceiling downwardly under a condition that the elastic restoring force of the leaf spring is applied to the ceiling.

The following patent Publication 2 discloses another type of mounting structure comprising an engagement member (mounting piece) attached to a lateral surface of a unit body of a lamp unit in a protrudable/retractable manner, wherein the engagement member is adapted, during an operation of mounting the unit body to a ceiling, to be manually moved to a protruding position where it protrudes from the unit body in such a manner as to be engaged with a back surface of the ceiling, and, during an operation of inserting/pulling out the unit body into/from the ceiling, to be manually moved to a retracted position. The mounting structure disclosed in the patent Publication 2 can eliminate a risk that the ceiling is damaged by the engagement member during the unit-body insertion/pullout operation.

However, the mounting structure disclosed in the patent Publication 2 obliges an operator to manually move the engagement member between the protruding and retracted positions. For example, during the operation of mounting the unit body to the ceiling, the operator has to manually move the engagement member from within the unit body, after inserting the unit body into an opening of the ceiling. In practice, before and after moving the engagement member outwardly to the protruding position, it is necessary to perform an additional operation of detaching an internal component of the unit body, such as a lamp bulb and a reflector, and re-attaching the detached internal component. The same additional operation is necessary to demount the mounted unit body.

As above, the mounting structure disclosed in the patent Publication 2 involves an extremely complicated operation to mounting/demounting the unit body to/from the ceiling. Thus, an operator is required to take a lot of time and effort for the operation. Moreover, an engaged state of the engagement member after being moved outwardly to the protruding position during the unit-body mounting operation is likely to become loose due to vibrations or the like. This causes the same problem about wobbling, or drooping/falling from the ceiling, as that in the leaf spring-based mounting structure.

The following patent Publication 3 discloses yet another type of mounting structure comprising a protrudable locking piece adapted to be moved to a protruding position in conjunction with a rotation of a rod which is a manual operation member, and a spring which generates a pressing force to be applied from the protrudable locking piece to a suspended ceiling. The mounting structure disclosed in the patent Publication 3 involves structural complexity, and requires a large mounting space. Thus, it is difficult to apply this mounting structure to a small lamp unit.

The following patent Publication 4 discloses still another type of mounting structure comprising a clamping plate adapted to be turned in conjunction with a rotation of a shaft, and moved by a biasing force of a spring in such a manner as to clamp a ceiling. The mounting structure disclosed in patent Publication 4 has difficulty in ensuring strength of the clamping plate, because it is composed of a single piece of plate. Thus, it is difficult to apply this mounting structure to a small lamp unit.

[Patent Publication 1] Japanese Patent Laid-Open Publication No. 04-062709

[Patent Publication 2] Japanese Utility Model Laid-Open Publication No. 05-036706

[Patent Publication 3] Japanese Patent Laid-Open Publication No. 2003-158388

[Patent Publication 4] Japanese Patent Laid-Open Publication No. 10-214511

### DISCLOSURE OF THE INVENTION

In view of the above circumstances, it is an object of the present invention to provide a ceiling recessed-type lamp unit capable of facilitating recessedly mounting a unit body to a ceiling, while ensuring the reliability of mounting the unit body to the ceiling, regardless of a lamp unit's size.

In order to achieve the above object, the present invention provides a ceiling recessed-type lamp unit designed to be recessedly mounted in an opening formed in a ceiling. The ceiling recessed-type lamp unit comprises a unit body adapted to be recessed in the ceiling, a support member fixed to the unit body, an engagement member supported by the support body in a vertically movable manner and in a rotatable manner about a vertical axis of the engagement member, and an elastic member which applies a downward biasing force to the engagement member. In the ceiling recessed-type lamp unit, the support member is composed of a single piece of plate which is a separate component from the unit body, and formed with a latch portion adapted to engage the engagement member, and a guide slot successively extending from the latch portion downwardly. The support member is adapted to adjustably change a vertical fixing position thereof relative to the unit body. The engagement member is composed of a single piece of bar which has an intermediate portion bent in a U shape to serve as a first engagement portion engageable with the latch portion of the support member, and a distal end bent to serve as a second engagement portion engageable with a back surface of the ceiling. The engagement member is adapted to be moved upwardly along the guide slot against the downward biasing force of the elastic member and then rotated in a first direction about the vertical axis, so that the first engagement portion is latchedly engaged with the latch portion to allow the engagement member to be set in a non-engagement position where the second engagement portion is retracted to extend along a lateral surface of the unit body so as to avoid engagement with the back surface of the ceiling. The engagement member is adapted, when it is in the non-engagement position, to be rotated in a second direction opposite to the first direction to release the engagement between the first engagement portion and the latch portion, so that the engagement member is moved downwardly along the guide slot by the downward biasing force of the elastic member, and set in an engagement position where the second engagement portion is positioned to protrude laterally outwardly from the unit body and engaged with the back surface of the ceiling, wherein the first engagement portion in the engagement position is located in the guide slot in such a manner as to have interference with a surface of the support plate defining the guide slot to maintain the engagement position.

The ceiling recessed-type lamp unit of the present invention has the above feature. Thus, in an operation of recessedly mounting the unit body to the ceiling, the engagement member is preliminarily set in the non-engagement position, and the unit body is inserted into the opening of the ceiling. Then, the engagement member is set in the engagement position simply by rotating the engagement member in the second direction. This makes it possible to facilitate recessedly mounting the unit body to the ceiling, regardless of a lamp unit's size. Furthermore, the engagement member in the engagement position is continuously applied with the downward biasing force from the elastic member. Thus, the engagement position can be stably maintained to allow the unit body to be reliably mounted to the ceiling, while preventing the unit body from wobbling, or drooping/falling down from the ceiling.

In the ceiling recessed-type lamp unit of the present invention, when the engagement member is in the engagement position, the first engagement portion of the engagement member is located in the guide slot of the support member in such a manner as to have interference with the guide slot-defining surface to maintain the engagement position. Thus, the engagement position can be reliably maintained to allow the unit body to be more reliably mounted to the ceiling, in cooperation with the downward biasing force of the elastic member.

Preferably, the ceiling recessed-type lamp unit of the present invention further includes shock attenuation means for attenuating shock occurring when the engagement member is brought into engagement with the back surface of the ceiling after being moved downwardly by the downward biasing force of the elastic member. In the ceiling recessed-type lamp unit provided with the shock attenuation means, when the engagement member is brought into engagement with the back surface of the ceiling after being moved downwardly by the downward biasing force of the elastic member, resulting shock can be attenuated to prevent damage to the ceiling. In the ceiling recessed-type lamp unit devoid of the shock attenuation means, there exists a need for setting the downward biasing force of the elastic member in a limited range in order to prevent damage to the ceiling, in some cases. In contrast, the ceiling recessed-type lamp unit provided with the shock attenuation means can employ an elastic member having a relatively strong downward biasing force, to allow the unit body to be more reliably mounted to the ceiling, while reliably preventing the unit body from wobbling, or drooping/falling down from the ceiling.

In a specific embodiment, the shock attenuation means may comprise a convex portion which is provided in the surface of the support plate defining the guide slot, and adapted to come into contact with the engagement member being moved downwardly along the guide slot, so as to attenuate shock occurring when the engagement member is brought into engagement with the back surface of the ceiling. Alternatively, the shock attenuation means may comprise a shock-absorbing member attached onto the second engagement portion of the engagement member.

In ceiling recessed-type lamp unit of the present invention, the engagement member is moved from the non-engagement position to the engagement position by manually rotating the first engagement portion of the engagement portion, as mentioned above. Preferably, the operation of manually rotating the engagement portion is performed using a manual tool adapted to be inserted from an opening (or hole, gap, etc.) in a bottom of the unit body. In view of facilitating the operation of rotating the first engagement portion using the manual tool, the elastic member applying the downward biasing force to the engagement member is preferably disposed above the first engagement portion of the engagement member. Specifically, when the elastic member is disposed above the first engagement portion of the engagement member, the first engagement portion of the engagement member can be disposed on a downward side accordingly, to facilitate the operation of rotating the first engagement portion using the manual tool which is to be inserted from the opening in the bottom of the unit body. This makes it possible to provide more enhanced efficiency in the operation of recessedly mounting the unit body to the ceiling. According to need, the engagement member in the engagement position can be moved upwardly and then rotated to return to the non-engagement position. Preferably, this operation is also performed using a manual tool adapted to be inserted from an opening (or hole, gap, etc.) in the bottom of the unit body.

Preferably, in the ceiling recessed-type lamp unit of the present invention, the unit body has a lateral plate formed with a slide slot extending vertically, and the support member is engaged with the slide slot vertically slidably in such a manner as to adjustably change a vertical fixing position of the support member relative to the unit body in a continuous manner. According to this feature, in an operation of changing the vertical fixing position of the support member depending on a thickness of a ceiling board in a mounting site, a need for taking out a fixation screw can be eliminated to provide more enhanced efficiency of the mounting operation.

As above, the ceiling recessed-type lamp unit of the present invention can facilitate recessedly mounting a unit body to a ceiling in a reliable manner, regardless of a lamp unit's size.

### BRIEF DESCRIPTION OF DRAWINGS

FIG. 1 is a sectional view showing a ceiling recessed-type lamp unit according to a first embodiment of the present invention, in a mounted state.

FIGS. 2(a) and 2(b) specifically show a support member and an engagement member in the ceiling recessed-type lamp unit illustrated in FIG. 1, in a state when the engagement member is set in a non-engagement position, wherein FIG. 2(a) is a front view, and FIG. 2(b) is a side view.

FIGS. 3(a) and 3(b) specifically show the support member and the engagement member in the ceiling recessed-type lamp unit illustrated in FIG. 1, in a state when the engagement member is set in an engagement position, wherein FIG. 3(a) is a front view, and FIG. 3(b) is a side view.

FIG. 4 is a sectional view showing a ceiling recessed-type lamp unit according to a second embodiment of the present invention, in a mounted state.

FIGS. 5(a) and 5(b) specifically show a support member and an engagement member in the ceiling recessed-type lamp unit illustrated in FIG. 4, in a state when the engagement member is set in a non-engagement position, wherein FIG. 5(a) is a front view, and FIG. 5(b) is a side view.

FIGS. 6(a) and 6(b) specifically show the support member and the engagement member illustrated in FIG. 4, in a state when the engagement member is set in an engagement position, wherein FIG. 6(a) is a front view, and FIG. 6(b) is a side view.

### EXPLANATION OF CODES

1: unit body
1a: lateral plate
1b: attaching hole
1c: cutout
1d: lower flange
1e: operation hole
1f: slide slot
2: reflector
3: support member
3a: support portion
3b: latch portion
3c: guide slot
3d: inclined surface
3e, 3f: convex portion
4: engagement member
4a: first engagement portion
4b: second engagement portion
4c: spring-retaining portion
4d: shock-absorbing member
5: coil spring (elastic member)
6: screw

### BEST MODE FOR CARRYING OUT THE INVENTION

The present invention will now be described based on an embodiment thereof illustrated in the drawings.

### First Embodiment

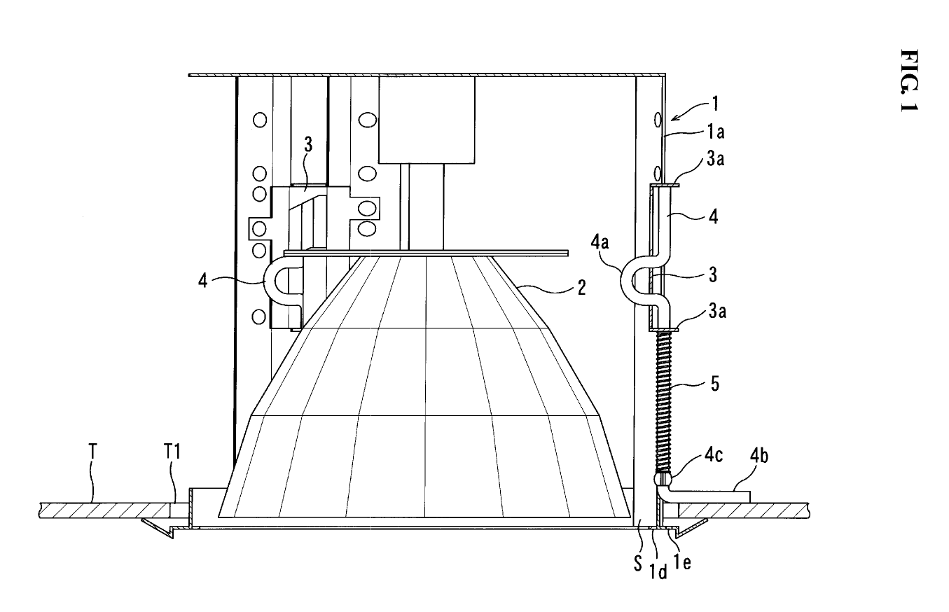

FIG. 1 is a sectional view showing a ceiling recessed-type lamp unit according to a first embodiment of the present invention, in a mounted state. As shown in FIG. 1, the ceiling recessed-type lamp unit according to the first embodiment comprises a unit body 1 adapted to be inserted from an opening T1 formed in a ceiling T, and recessedly mounted to the ceiling T (i.e., mounted to the ceiling T in a recessed manner or in a substantially flush-mounted manner). The unit body 1 internally has a hat-shaped reflector 2, and a lamp bulb (not shown) disposed inside the reflector 2.

The lamp unit includes a support member 3 fixed to a lateral plate 1a of the unit body 1, and an engagement member 4 supported by upper and lower support portions 3a, 3a of the support member 3 in a vertically (i.e., upwardly and downwardly) movable manner and in a rotatable manner about a vertical (i.e., upward/downward) axis of the engagement member 4. The engagement member 4 is adapted to be engaged with a back surface of the ceiling T through a lower end (i.e., distal end) of an after-mentioned second engagement portion 4a thereof, so that the unit body 1 is retained by the ceiling T in a recessed manner. The lamp unit further includes a coil spring 5 (serving as an elastic member) attached to a lower portion of the engagement member 4. The coil spring 5 has an upper end in contact with the lower support portion 3a of the support member 3, and a lower end retained by a spring-retaining portion 4c of the engagement member 4. Thus, the coil spring 5 continuously applies a downward biasing force to the engagement member 4. The combined structure consisting of the support member 3 and the engagement member 4 is provided in a number of three, and the three combined structures are fixed around a lateral surface of the unit body 1 at even intervals.

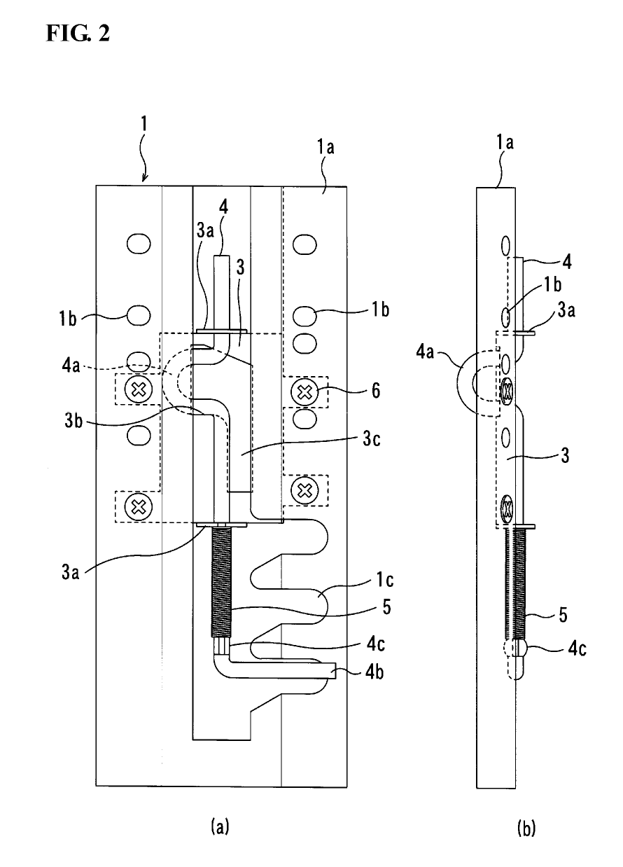

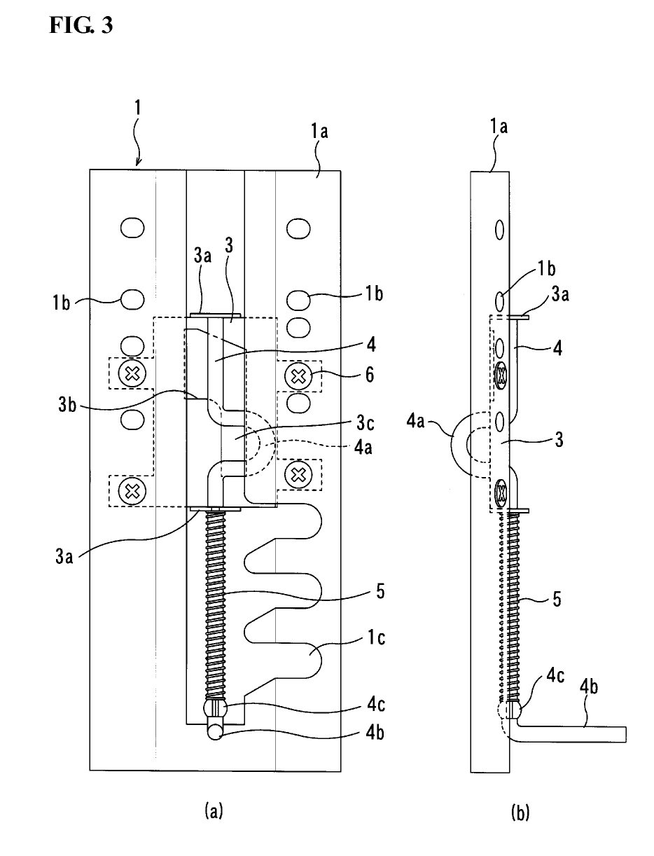

FIGS. 2(a), 2(b), 3(a) and 3(b) specifically show the support member 3 and the engagement member 4. FIGS. 2(a) and 2(b) illustrate a state when the engagement member 4 is set in a non-engagement position where the after-mentioned second engagement portion 4b of the engagement member 4 is retracted to extend along a lateral surface of the unit body 1, and FIGS. 3(a) and 3(b) illustrate a state when the engagement member 4 is set in an engagement position where the after-mentioned second engagement portion 4b of the engagement member 4 is positioned to protrude laterally outwardly from the unit body 1. FIGS. 2(a) and 3(a) are front views, and FIGS. 2(b) and 3(b) are side views.

The support member 3 is composed of a single piece of plate which is a separate component from the unit body 1. The support member 3 is positioned relative to given ones selected from of a plurality of attaching holes 1b formed in the lateral plate 1a of the unit body 1 at a plurality of different heights, and fixed to the lateral plate 1a using screws 6. The support member 3 is formed with a latch portion 3b adapted to engage an after-mentioned first engagement portion 4b of the engagement member 4, and a guide slot 3c successively extending from the latch portion 3b downwardly. A boundary portion between the latch portion 3b and the guide slot 3c is formed as a rounded corner.

As mentioned above, the support member 3 is composed of a single piece of plate. Thus, each of the latch portion 3b and the guide slot 3c can be readily formed only by subjecting a plate to a slot-machining process, and the support portions 3a, 3a can also be readily formed only by subjecting the plate to a bending process. Similarly, the lateral plate 1a of the unit body 1 is composed of a single piece of plate which is a separate component from the remaining components of the unit body 1. The lateral plate 1a is detachably assembled to the remaining components of the unit body 1 using a screw or the like. The attaching holes 1b and after-mentioned cutouts 1c can be readily formed only by subjecting a plate to a hole-machining process or a slot-machining process.

The engagement member 4 is composed of a single piece of bar, such as a metal bar, and supported by the upper and lower support portions 3a, 3a of the support member 3 in a vertically movable manner and in a rotatable manner about the vertical axis, as mentioned above. The engagement member 4 has an intermediate portion bent in a U shape to serve as a first engagement portion 4a engageable with the latch portion 3b of the support member 3, and a lower end (i.e., distal end) subjected to a bending process to serve as a second engagement portion 4b engageable with the back surface of the ceiling T, as illustrated in FIG. 1.

In an operation of recessedly mounting the above unit body 1 to the ceiling T, the engagement member 4 is preliminarily set in the non-engagement position as illustrated in FIGS. 2(a) and 2(b). For the preliminary operation of setting the engagement member 4 in the non-engagement position, the engagement member 4 is moved upwardly along the guide slot 3 against the downward biasing force of the coil spring 5 and then rotated in a first direction (in the first embodiment, a clockwise direction when the engagement member 4 is viewed upwardly from therebelow) about the vertical axis, so that the first engagement portion 4a is latchedly engaged with the latch portion 3b of the support member 3. In the non-engagement position, the second engagement portion 4b of the engagement member 4 is retracted to extend along a lateral surface (of the lateral plate 1a) of the unit body 1 so as to avoid engagement with the back surface of the ceiling T. Thus, the unit body 1 can be inserted from the opening T1 of the ceiling T into a space on the side of the back surface of the ceiling. In the first embodiment, the lateral plate 1a of the unit body 1 is formed with a plurality of cutouts 1c at respective different heights to allow the second engagement portion 4b of the engagement member 4 to be retracted to extend along one of the cutouts 1c.

After inserting the unit body 1 from the opening T1 of the ceiling T into the space on the side of the back surface of the ceiling T and holding the unit body 1 at a given position, the engagement member 4 is rotated in a second direction opposite to the first direction. Through this operation, the engagement between the first engagement portion 4a of the engagement member 4 and the latch portion 3b of the support member 3 is released to allow the engagement member 4 to be moved downwardly along the guide slot 3c by the downward biasing force of the coil spring 5 and stopped at a lower end of the guide slot 3c. Thus, the engagement member 4 is set in an engagement position where the second engagement portion 4b of the engagement member 4 is positioned to protrude laterally outwardly from the unit body 1 and engaged with the back surface of the ceiling T, as illustrated in FIG. 1. Specifically, as shown in FIGS. 2(a) to 3(b), a position on the vertical axis of the engagement member 4 (a position on a line connecting the upper and lower support portions 3a, 3a of the support member 3) is located at a position corresponding to the rounded corner which is the boundary portion between the latch portion 3b and the guide slot 3c. Thus, the first engagement portion 4a is moved from the latch portion 3b into the guide slot 3c through the corner only by rotating the engagement member 4 in the second direction, and then the engagement member 4 will be guided to the engagement position.

As shown in FIGS. 3(a) and 3(b), in the engagement position, the first engagement portion 4a of the engagement member 4 is located in the guide slot 3c in such a manner as to have interference with a surface of the support plate 3 defining the guide slot 3c. Thus, the engagement member 4 is precluded from rotation about the vertical axis, and thereby the engagement position is reliably maintained.

As mentioned above, the operation of rotating the engagement member 4 in the second direction is necessary for moving the engagement member 4 from the non-engagement position to the engagement position. In the first embodiment, a gap S (see FIG. 1) is defined between the lateral plate 1a of the unit body 1 and an outer peripheral surface of the reflector 2, so that a manual tool, e.g., a spatula-shaped tool, can be inserted from the gap S and manually operated to rotate the first engagement portion 4a of the engagement member 4 in the second direction. Thus, after inserting the unit body 1 from the opening T1 of the ceiling T into the space on the side of the back surface of the ceiling T, the engagement member 4 can be readily set in the engagement position. Furthermore, in the first embodiment, the second direction in each of the first engagement portions 4a of the three engagement members 4 arranged at the respective positions is uniformly oriented. Thus, each of the three engagement members 4 can be set in the engagement position only by rotating the spatula-shaped tool in one direction.

The operation of moving the engagement member 4 upwardly along the guide slot 3c against the downward biasing force of the coil spring 5 and then rotating the engagement member 4 in the first direction is necessary for moving the engagement member 4 from the engagement position to the non-engagement position. In the first embodiment, the unit body 1 has a lower flange 1d formed with an operation hole 1e, as shown in FIG. 1, so that a manual tool, such as a bar-shaped tool, can be inserted from the operation hole 1e to clamp the second engagement portion 4b of the engagement member 4 from therebelow, and manually operated to move the engagement member 4 upwardly and then rotate the engagement member 4 in the first direction so as to return to the non-engagement position. Thus, the operation of demounting the unit body 1 can also be facilitated without damage to the ceiling T.

In the first embodiment, the plurality of attaching holes 1b are formed at the plurality of different heights to fix the support plate 3 to the unit body 1. Thus, ones of the attaching holes 1b can be selected to change a vertical fixing position of the support member 3 relative to the unit body 1, i.e., a vertical support position of the engagement member 4 relative to the unit body 1. This makes it possible to adjust a vertical position of the second engagement portion 4b engageable with the back surface of the ceiling T, depending on a thickness of a ceiling board in a mounting site. For example, when the unit body 1 is mounted to a ceiling board having a thickness greater than that of a ceiling board of the ceiling T illustrated in FIG. 1, the support member 3 will be fixed to the unit body 1 using upper ones selected from the attaching holes 1b. Furthermore, the plurality of cutouts 1c allowing the second engagement portion 4b to be retracted during the operation of setting the engagement member 4 in the non-engagement position are formed at respective heights corresponding to the selectable vertical support positions of the engagement member 4. Thus, a change in the vertical support position of the engagement member 4 never causes any problem.

### Second Embodiment

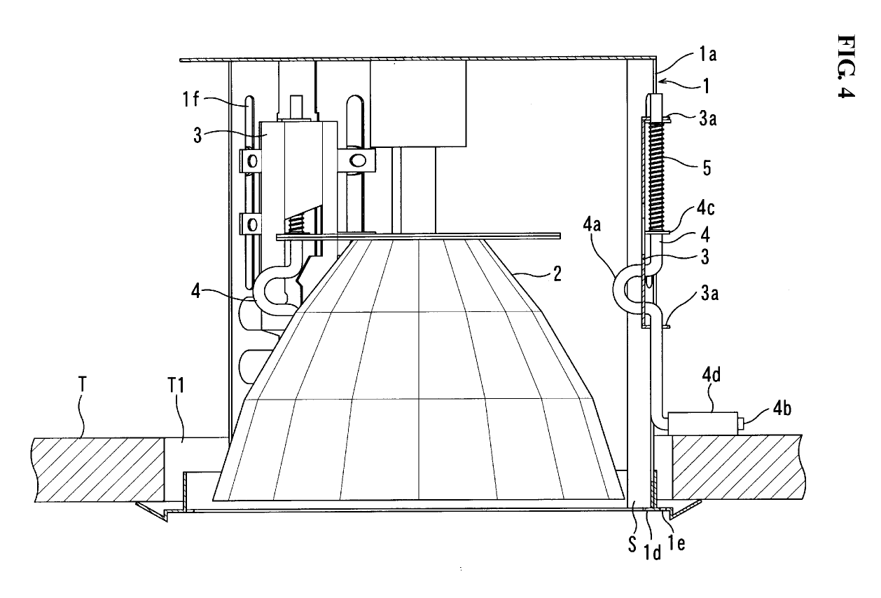

FIG. 4 is a sectional view showing a ceiling recessed-type lamp unit according to a second embodiment of the present invention, in a mounted state. As with the first embodiment, the ceiling recessed-type lamp unit illustrated in FIG. 4 comprises a unit body 1 adapted to be inserted from an opening T1 formed in a ceiling T, and recessedly mounted to the ceiling T. The unit body 1 internally has a hat-shaped reflector 2, and a lamp bulb (not shown) disposed inside the reflector 2.

The lamp unit includes a support member 3 fixed to a lateral plate 1a of the unit body 1, and an engagement member 4 supported by upper and lower support portions 3a, 3a of the support member 3 in a vertically movable manner and in a rotatable manner about a vertical axis of the engagement member 4. The engagement member 4 is adapted to be engaged with a back surface of the ceiling T through a lower end (i.e., distal end) of an after-mentioned second engagement portion 4a thereof, so that the unit body 1 is retained by the ceiling T in a recessed manner. The lamp unit further includes a coil spring 5 (serving as an elastic member) attached to an upper portion of the engagement member 4. The coil spring 5 has an upper end in contact with the upper support portion 3a of the support member 3, and a lower end retained by a spring-retaining portion 4c of the engagement member 4. Thus, the coil spring 5 continuously applies a downward biasing force to the engagement member 4. The combined structure consisting of the support member 3 and the engagement member 4 is provided in a number of three, and the three combined structures are fixed around a lateral surface of the unit body 1 at even intervals.

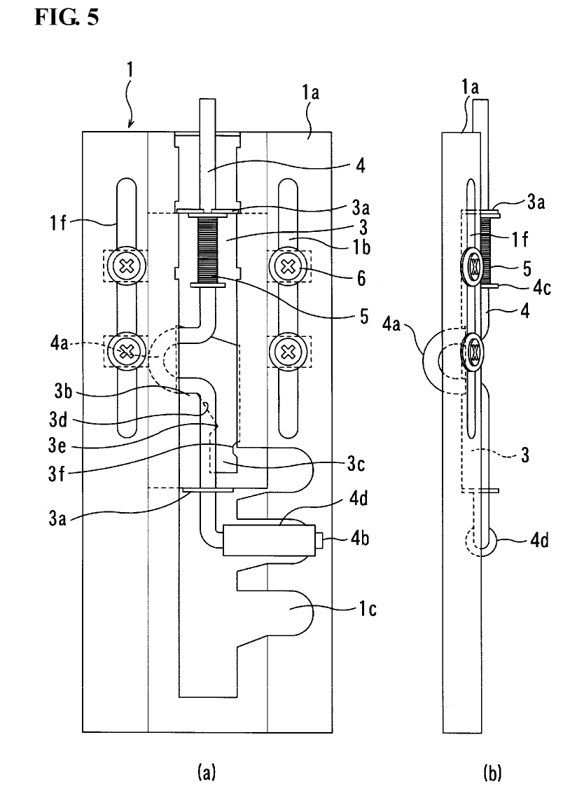

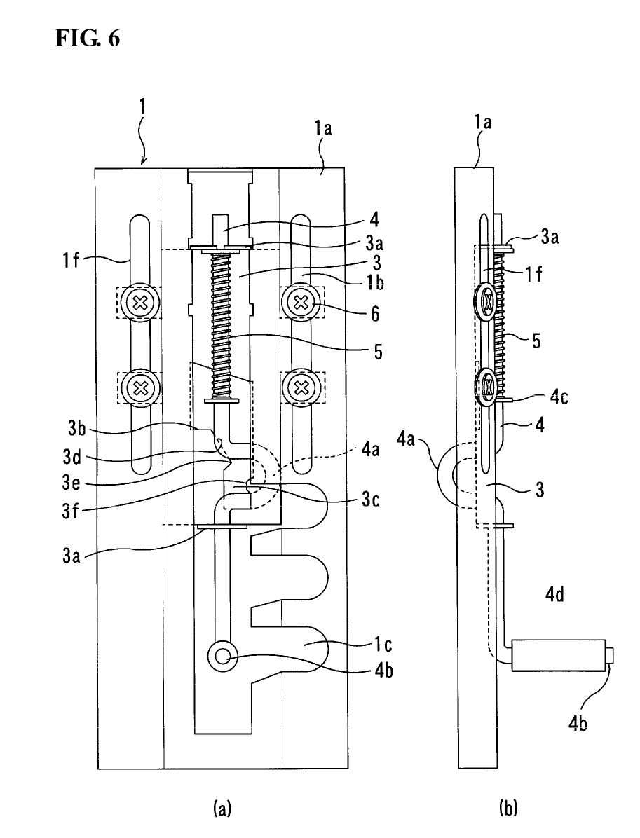

FIGS. 5(a), 5(b), 6(a) and 6(b) specifically show the support member 3 and the engagement member 4. FIGS. 5(a) and 5(b) illustrate a state when the engagement member 4 is set in a non-engagement position where the after-mentioned second engagement portion 4b of the engagement member 4 is retracted to extend along a lateral surface of the unit body 1, and FIGS. 6(a) and 6(b) illustrate a state when the engagement member 4 is set in an engagement position where the after-mentioned second engagement portion 4b of the engagement member 4 is positioned to protrude laterally outwardly from the unit body 1. FIGS. 5(a) and 6(a) are front views, and FIGS. 5(b) and 6(b) are side views.

The support member 3 is composed of a single piece of plate which is a separate component from the unit body 1. The support member 3 is positioned relative to a pair of slide slots 1f formed in respective opposite side portions of the lateral plate 1a of the unit body 1 to extend vertically, and fixed to the lateral plate 1a using screws 6. Each of the screws 6 is threadingly engaged with the lateral plate 1a of the unit body 1. Thus, the screws 6 can be loosened to allow the support member 3 to be slidably moved along the slide slots. The screws 6 can be reversely tightened to allow the support member 3 to be to be fixed to the lateral plate 1a of the unit body 1. In this manner, the support member 3 is engaged with the slide slots 1f through the screws 6 to adjustably change a vertical fixing position of the support member 3.

The support member 3 is formed with a latch portion 3b adapted to engage an after-mentioned first engagement portion 4b of the engagement member 4, and a guide slot 3c successively extending from the latch portion 3b downwardly. A boundary portion between the latch portion 3b and the guide slot 3c is formed as an inclined surface 3d which extends obliquely downwardly from the latch portion 3b to the guide slot 3c.

The surface of the support plate 3 defining the guide slot 3b (this surface will hereinafter refereed to as “guide slot-defining surface”) is formed with two convex portion 3e, 3f serving as shock attenuation means set forth in the appended claims. The convex portion 3e is formed in an upper end of one of opposed regions of the guide slot-defining surface in such a manner as to continue from a lower end of the inclined surface 3d, and the convex portion 3f is formed in the other region (i.e., region opposed to the convex portion 3e) of the guide slot-defining surface and on a slightly downward side relative to the convex portion 3e.

As mentioned above, the support member 3 is composed of a single piece of plate. Thus, each of the latch portion 3b, the guide slot 3c and the convex portions 3e, 3f can be readily formed only by subjecting a plate to a slot-machining process, and the support portions 3a, 3a can also be readily formed only by subjecting the plate to a bending process. Similarly, the lateral plate 1a of the unit body 1 is composed of a single piece of plate which is a separate component from the remaining components of the unit body 1. The lateral plate 1a is detachably assembled to the remaining components of the unit body 1 using a screw or the like. The slide slots 1f and after-mentioned cutouts 1c can be readily formed only by subjecting a plate to a slot-machining process.

The engagement member 4 is composed of a single piece of bar, such as a metal bar, and supported by the upper and lower support portions 3a, 3a of the support member 3 in a vertically movable manner and in a rotatable manner about the vertical axis, as mentioned above. The engagement member 4 has an intermediate portion bent in a U shape to serve as a first engagement portion 4a engageable with the latch portion 3b of the support member 3, and a lower end (i.e., distal end) subjected to a bending process to serve as a second engagement portion 4b engageable with the back surface of the ceiling T, as illustrated in FIG. 4. The second engagement portion 4b has a shock-absorbing member 4d made of rubber and attached thereon to serve as the shock attenuation means set forth in the appended claims.

In an operation of recessedly mounting the above unit body 1 to the ceiling T, the engagement member 4 is preliminarily set in the non-engagement position as illustrated in FIGS. 5(a) and 5(b). For the preliminary operation of setting the engagement member 4 in the non-engagement position, the engagement member 4 is moved upwardly along the guide slot 3 against the downward biasing force of the coil spring 5 and then rotated in a first direction (in the second embodiment, a clockwise direction when the engagement member 4 is viewed upwardly from therebelow) about the vertical axis, so that the first engagement portion 4a is latchedly engaged with the latch portion 3b of the support member 3. In the non-engagement position, the second engagement portion 4b of the engagement member 4 is retracted to extend along a lateral surface (of the lateral plate 1a) of the unit body 1 so as to avoid engagement with the back surface of the ceiling T. Thus, the unit body 1 can be inserted from the opening T1 of the ceiling T into a space on the side of the back surface of the ceiling. In the second embodiment, the lateral plate 1a of the unit body 1 is formed with a plurality of cutouts 1c at respective different heights to allow the second engagement portion 4b of the engagement member 4 to be retracted to extend along one of the cutouts 1c.

After inserting the unit body 1 from the opening T1 of the ceiling T into the space on the side of the back surface of the ceiling T and holding the unit body 1 at a given position, the engagement member 4 is rotated in a second direction opposite to the first direction. Through this operation, the engagement between the first engagement portion 4a of the engagement member 4 and the latch portion 3b of the support member 3 is released to allow the engagement member 4 to be moved downwardly along the guide slot 3c by the downward biasing force of the coil spring 5 and stopped at a lower end of the guide slot 3c. Thus, the engagement member 4 is set in an engagement position where the second engagement portion 4b of the engagement member 4 is positioned to protrude laterally outwardly from the unit body 1 and engaged with the back surface of the ceiling T, as illustrated in FIG. 4. Specifically, as shown in FIGS. 5(a) to 6(b), a position on the vertical axis of the engagement member 4 (a position on a line connecting the upper and lower support portions 3a, 3a of the support member 3) is located at a position corresponding to the inclined surface 3d which is the boundary portion between the latch portion 3b and the guide slot 3c. Thus, the first engagement portion 4a is moved from the latch portion 3b into the guide slot 3c through the inclined surface 3d only by rotating the engagement member 4 in the second direction, and then the engagement member 4 will be guided to the engagement position.

As shown in FIGS. 6(a) and 6(b), in the engagement position, the first engagement portion 4a of the engagement member 4 is located in the guide slot 3c in such a manner as to have interference with the guide slot-defining surface of the support plate 3. Thus, the engagement member 4 is precluded from rotation about the vertical axis, and thereby the engagement position is reliably maintained.

In the second embodiment, the convex portions 3e, 3f are provided on the guide slot-defining surface of the support plate 3. Thus, each of the convex portions 3e, 3f comes into contact with the first engagement portion 4a of the engagement member 4 being moved downwardly along the guide slot 3c, to attenuate shock occurring when the second engagement portion 4b of the engagement member 4 is brought into contact with the back surface of the ceiling. Specifically, the guide slot 3c is curved in an S shape due to the convex portions 3e, 3f to create a resistance against passage of the first engagement portion 4a so as to attenuate the shock. In addition, the shock-absorbing member 4d is attached on the second engagement portion 4b so as to further attenuate the shock. This shock attenuation function makes it possible to prevent damage to the ceiling even if a coil spring 5 having a relatively strong biasing force is employed as an elastic member set forth in the appended claims. That is, an elastic member having a relatively strong biasing force can be employed to reliably mount the unit body to the ceiling while reliably preventing the unit body from wobbling, or drooping/falling down from the ceiling.

As mentioned above, the operation of rotating the engagement member 4 in the second direction is necessary for moving the engagement member 4 from the non-engagement position to the engagement position. In the second embodiment, a gap S (see FIG. 4) is defined between the lateral plate 1a of the unit body 1 and an outer peripheral surface of the reflector 2, so that a manual tool, e.g., a spatula-shaped tool, can be inserted from the gap S and manually operated to rotate the first engagement portion 4a of the engagement member 4 in the second direction. Thus, after inserting the unit body 1 from the opening T1 of the ceiling T into the space on the side of the back surface of the ceiling T, the engagement member 4 can be readily set in the engagement position. Furthermore, in the second embodiment, the coil spring 5 is attached to an upper portion of the engagement member 4, and the first engagement portion 4a of the engagement member 4 is disposed on a downward side close to the gap S, accordingly. This makes it possible to facilitate the operation of moving the first engagement portion 4a using the aforementioned spatula-shaped tool. In the second embodiment, the second direction in each of the first engagement portions 4a of the three engagement members 4 arranged at the respective positions is uniformly oriented. Thus, each of the three engagement members 4 can be set in the engagement position only by rotating the spatula-shaped tool in one direction.

The operation of moving the engagement member 4 upwardly along the guide slot 3c against the downward biasing force of the coil spring 5 and then rotating the engagement member 4 in the first direction is necessary for moving the engagement member 4 from the engagement position to the non-engagement position. In the second embodiment, the unit body 1 has a lower flange 1d formed with an operation hole 1e, as shown in FIG. 4, so that a manual tool, such as a bar-shaped tool, can be inserted from the operation hole 1e to clamp the second engagement portion 4b of the engagement member 4 from therebelow, and manually operated to move the engagement member 4 upwardly and then rotate the engagement member 4 in the first direction so as to return to the non-engagement position. Thus, the operation of demounting the unit body 1 can also be facilitated without damage to the ceiling T.

In the second embodiment, the support member 3 supporting the engagement member 4 is adapted to be slidably moved along the slide grooves 1c formed in the lateral plate 1a of the unit body 1 so as to adjustably change the vertical fixing position of the support member 3. This makes it possible to adjust a vertical position of the second engagement portion 4b engageable with the back surface of the ceiling T, depending on a thickness of a ceiling board in a mounting site. For example, when the unit body 1 is mounted to a ceiling board having a thickness greater than that of a ceiling board of the ceiling T illustrated in FIG. 4, the support member 3 will be slidably moved upwardly, and then fixed. This sliding movement can be allowed only by loosening the screws 6. Thus, the vertical fixing position of the support member 3 (or the vertical support position of the engagement member 4) can be readily changed without involving a bothersome operation of detaching and re-attaching the screws 6. Furthermore, the plurality of cutouts 1c allowing the second engagement portion 4b to be retracted during the operation of setting the engagement member 4 in the non-engagement position are formed at respective heights corresponding to the selectable vertical support positions of the engagement member 4. Thus, a change in the vertical support position of the engagement member 4 never causes any problem.

What is claimed is:

1. A ceiling recessed-type lamp unit designed to be recessedly mounted in an opening formed in a ceiling, comprising:
a unit body adapted to be recessed in the ceiling;
a support member fixed to said unit body;
an engagement member supported by said support body in a vertically movable manner and in a rotatable manner about a vertical axis of said engagement member; and
an elastic member which applies a downward biasing force to said engagement member,
wherein:
said support member is composed of a single piece of plate which is a separate component from said unit body, and formed with a latch portion adapted to engage said engagement member, and a guide slot successively extending from said latch portion downwardly, said support member being adapted to adjustably change a vertical fixing position thereof relative to said unit body; and
said engagement member is composed of a single piece of bar which has an intermediate portion bent in a U shape to serve as a first engagement portion engageable with said latch portion of said support member, and a distal end bent to serve as a second engagement portion engageable with a back surface of the ceiling, said engagement member being adapted to be moved upwardly along said guide slot against the downward biasing force of said elastic member and then rotated in a first direction about said vertical axis, so that said first engagement portion is latchedly engaged with said latch portion to allow said engagement member to be set in a non-engagement position where said second engagement portion is retracted to extend along a lateral surface of said unit body so as to avoid engagement with the back surface of the ceiling, said engagement member being adapted, when it is in said non-engagement position, to be rotated in a second direction opposite to said first direction to release said engagement between said first engagement portion and said latch portion, so that said engagement member is moved downwardly along said guide slot by the downward biasing force of said elastic member, and set in an engagement position where said second engagement portion is positioned to protrude laterally outwardly from said unit body and engaged with the back surface of the ceiling, wherein said first engagement portion in said engagement position is located in said guide slot in such a manner as to have interference with a surface of said support plate defining said guide slot to maintain said engagement position.

2. The ceiling recessed-type lamp unit as defined in claim 1, which further includes shock attenuation means for attenuating shock occurring when said engagement member is brought into engagement with the back surface of the ceiling after being moved downwardly by the downward biasing force of said elastic member.

3. The ceiling recessed-type lamp unit as defined in claim 2, wherein said shock attenuation means comprises a convex portion which is provided on the surface of said support member defining said guide slot, and adapted to come into contact with said engagement member being moved downwardly along said guide slot, so as to attenuate shock occurring when said engagement member is brought into engagement with the back surface of the ceiling.

4. The ceiling recessed-type lamp unit as defined in claim 2, wherein said shock attenuation means comprises a shock-absorbing member attached onto said second engagement portion of said engagement member.

5. The ceiling recessed-type lamp unit as defined in claim 1, wherein said elastic member applying said downward biasing force to said engagement member is disposed above said first engagement portion of said engagement member.

6. The ceiling recessed-type lamp unit as defined in claim 1, wherein:
said unit body has a lateral plate formed with a slide slot extending vertically; and
said support member is engaged with said slide slot vertically slidably in such a manner as to adjustably change a vertical mounting position of said support member relative to said unit body in a continuous manner.
